(19) United States
(12) Patent Application Publication
(10) Pub. No.: US 2025/0293477 A1
(43) Pub. Date: Sep. 18, 2025

(54) Laser Firing Circuit

(71) Applicants: Gunendran Sivapragasam, Glen Allen, VA (US); Andrew Roy Simpson, Fredericksburg, VA (US)

(72) Inventors: Gunendran Sivapragasam, Glen Allen, VA (US); Andrew Roy Simpson, Fredericksburg, VA (US)

(73) Assignee: Chief of Naval Research, Office of Counsel, Arlington, VA (US)

(21) Appl. No.: 18/603,706

(22) Filed: Mar. 13, 2024

(51) Int. Cl. H01S 3/09; F41H 13/00

(52) U.S. Cl. CPC H01S 3/09; F41H 13/005

(57) ABSTRACT

An electronic control circuit is provided for laser firing control. The control circuit includes a command circuit, an acknowledge circuit, an arming circuit and a firing circuit. The command circuit issues an initiation of the weapon by providing an authorization command signal. The acknowledge circuit interlocks the command signal and provides an interlock signal. The arming circuit issues an arming signal to energize the weapon in response to the interlock signal. The firing circuit issues a firing signal to activate the weapon in response to the arming signal. Additionally, the control circuit can further include a fire fault circuit to deactivate the firing circuit in response to inadequate power to the firing circuit.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to laser firing circuits. In particular, the invention relates to a universal control circuit for activating a high energy laser.

Directed energy weapons employ high-power laser emitters to deliver electromagnetic energy to a target. Such laser programs have historically developed their own Firing Circuits (FCs). This has resulted in repetitive efforts across the laser programs being conducted across the command resulting in cost and schedule overruns.

### SUMMARY

Conventional laser firing circuits yield disadvantages addressed by various exemplary embodiments of the present invention. In particular, various exemplary embodiments provide an electronic control circuit for laser firing control. The control circuit includes a command circuit, an acknowledge circuit, an arming circuit and a firing circuit. The command circuit issues an initiation of the weapon by providing an authorization command signal. The acknowledge circuit interlocks the command signal and provides an interlock signal.

The arming circuit issues an arming signal to energize the weapon in response to the interlock signal. The firing circuit issues a firing signal to activate the weapon in response to the arming signal. Additionally, the control circuit can further include a fire fault circuit to deactivate the firing circuit in response to inadequate power to the firing circuit.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a common firing circuit (CFC);

FIG. 2 is a block diagram view of the CFC components;

FIG. 3 is an electric circuit view of a converter circuit;

FIG. 4 is a logic circuit view of a gate latch configuration;

FIG. 5 is a graphical view of a voltage response;

FIG. 6 is a dialog box view of a voltage parameters;

FIG. 7 is a flowchart view of command and authorization interlocks;

FIGS. 8A and 8B are circuit board views of a CFC circuit board;

FIGS. 9A and 9B are wiring diagram views of the circuit board;

FIG. 10 is an electrical schematic view of an authorization portion;

FIG. 11 is an electrical schematic view of an arming portion; and

FIG. 12 is an electrical schematic view of a converter and interlinks portion.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The disclosure generally employs quantity units with the following abbreviations: mass in grams (g), time in seconds(s), angles in degrees (°), force in newtons (N), temperature in kelvins (K), electric potential in volts (V), resistance in ohms (Ω), capacitance in farads F), electric current in amperes (A), energy in joules (J), power in watts (W) and frequencies in hertz (Hz). Supplemental measures can be derived from these, such as density in grams-per-cubic-centimeters (g/cm³), moment of inertia in kilogram-square-meters (kg-m²) and the like.

Exemplary embodiments of a common firing circuit (CFC) have been developed for use across laser systems. This endeavor has been reviewed and incorporates inputs provided by members of the safety review boards, e.g., the Laser Safety Review Board (LSRB), Fuse and Initiation System Technical Review Panel (FISTRP) and Weapon System Explosive Safety Review Board (WSESRB).

Expected review and concurrence of a baseline CFC design by the safety review boards can streamline and expedite the engineering integration design process by laser programs. This should provide cost and schedule savings for all future directed programs. Naval Surface Warfare Center Dahlgren Division (NSWCDD) Code R44 was awarded an opportunity through an independent program to develop a proven concept of a CFC integration card design.

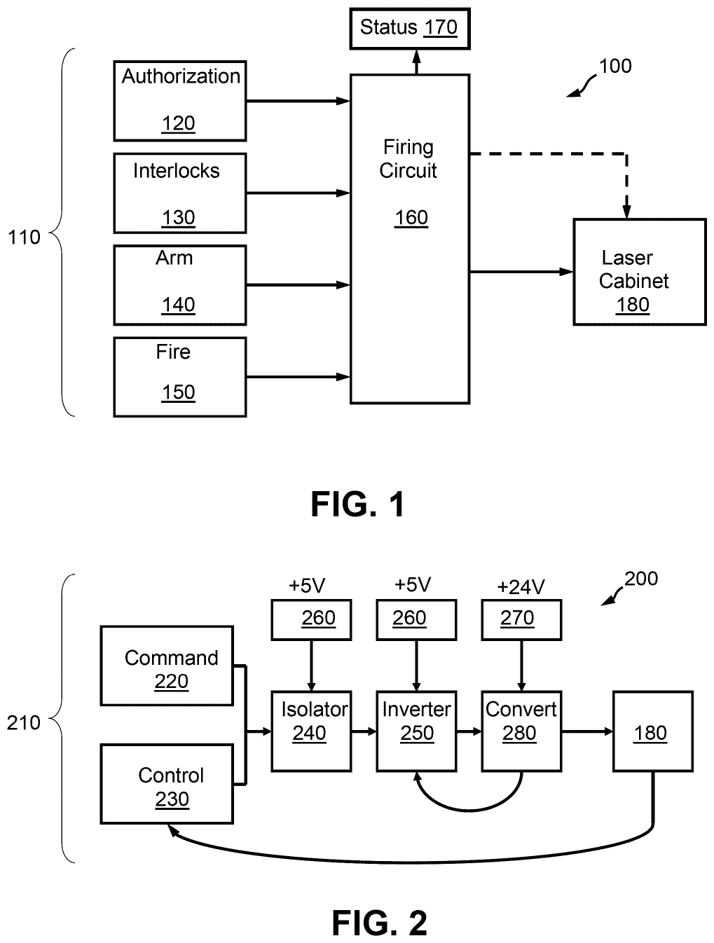

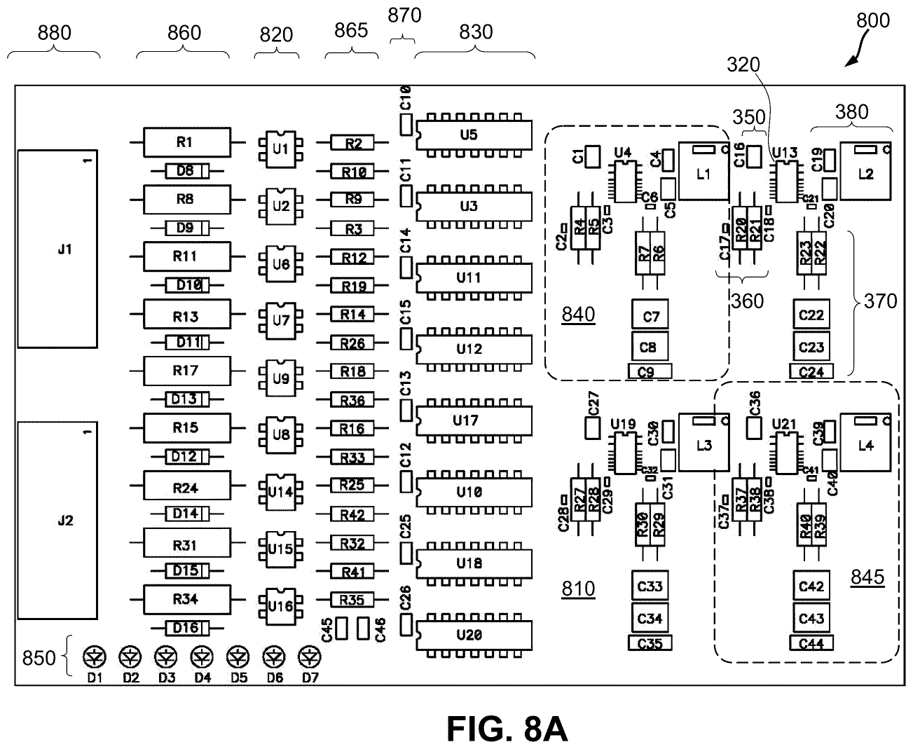

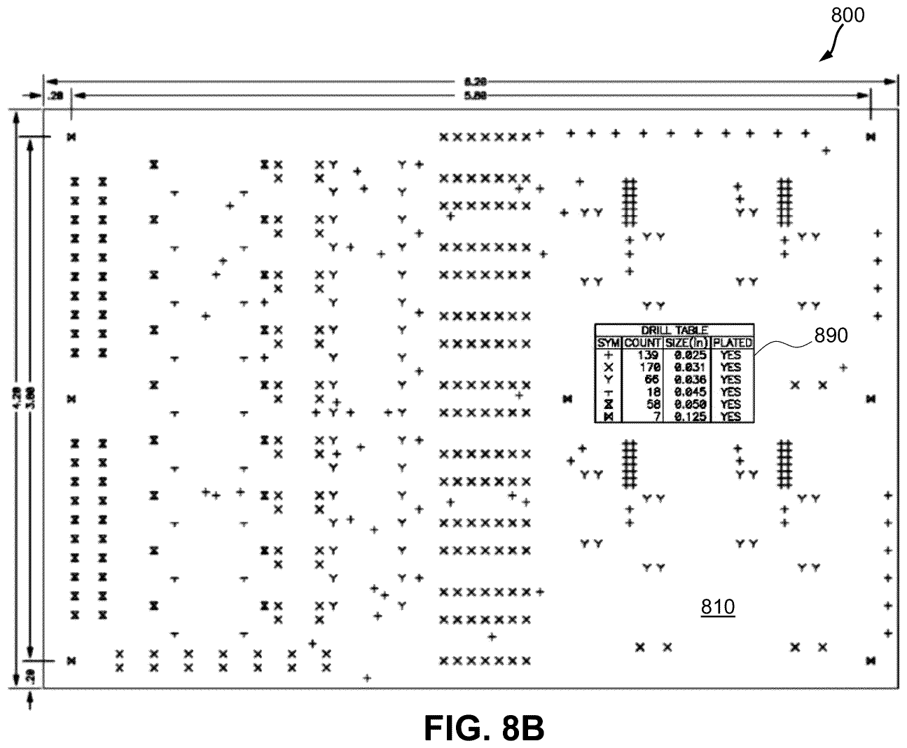

FIG. 1 shows a block diagram view 100 for the concept of an exemplary Common Firing Circuit (CFC) 110. The CFC integration card (810 in FIG. 8) has been designed to integrate existing weapon consoles to new laser weapon control cabinets. This circuit ensures a standardized approach in the laser weapon installation space, mitigating multiple system integration designs across laser programs. Various hardware components include light emitting diode (LED) and switch (SW).

Instructions for authorization 120, interlock 130, arming 140 and fire control 150 provide inputs to the firing circuit (FC) 160, while also receiving status 170. These instructions are fed from the FC 160 to a laser cabinet (LC) 180. All inputs on the left are provided by the weapon console while the laser cabinet 180 on the right receives all outputs from the CFC 110. This topology creates a progressive series of interlocks within the CFC integration card. Indications for FC status 170 are local to the initial prototype and visually display the buildup of stages of the CFC 110 across major signals provided to and from the laser cabinet 180. The laser cabinet 180 receives a power on/initialization signal from the FC 160, as well as the laser fire signal.

Authorization 120 includes master authorization key. Interlock 130 includes predictive avoidance (PA), emergency laser off (ELO) and abort system (e.g., hardware abort system, HWAS) to assess interlock status. Arming 140 includes arm switches for arm command. Fire control 150 includes hand controller and weapon controller for fire command.

FIG. 2 shows a block diagram view 200 of the CFC integration card circuit architecture 210 as a series of interlocks. The components include command (CMD) 220 and control 230 that connect to an isolator 240 leading to an inverter 250. Command 220 provides operational signals, e.g., authorization command, arming command, fire command. Control provides verification signals, e.g., authorization acknowledgement, console interlock and arming acknowledgement.

The isolators 240 can be galvanic opto-isolators PCB17. The inverters 250 can be interlock logic inverters SN74HC14N with .AND. gates SN74HC08N. Both isolator 240 and inverter 250 receive 5 V_{DC} bus input potential 260. Another 24 V_{DC} bus input potential 270 supplies a converter 280 from the inverter 250 and returns 12 V_{DC} output signals in a feedback loop. The converter 280 includes an LT8630 chip supplies the laser cabinet 180, which also provides feedback to the control 230 for operational output signals.

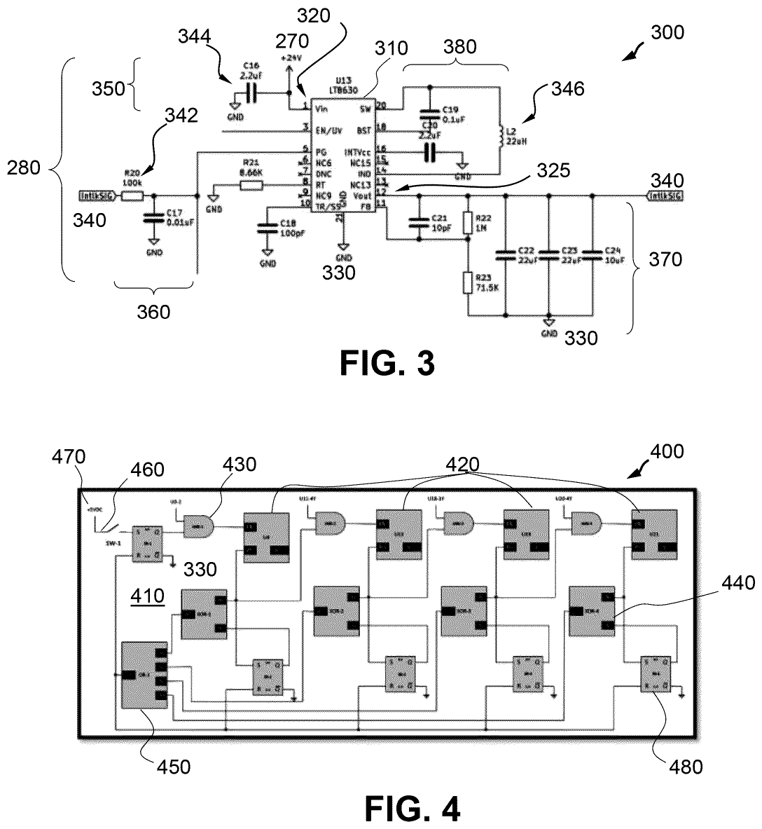

FIG. 3 shows an electric circuit view 300 of an LT8630 DC/DC architecture for an exemplary converter 280 operating with direct current (DC) powered by +24 V_{DC} electric potential 270. An integrated circuit (IC) U13 LT8630 chip 310 includes Vᵢₙ pin 1 as 320, which receives input potential 260, and Vₒᵤₜ pin 12 as 325. The converter 280 includes circuits connecting to a fixed potential called ground (GND) 330. Components include interlock signal (IntlkSIG) 340, as well as resistors 342, capacitors 344 and inductors 346.

Various circuits include connections to pin 1 for input voltage Vᵢₙ as 350, pin 5 for power-good (PG) as 360, pin 11 connecting to a parallel capacitor circuit 370 and to pin 12 Vₒᵤₜ 325, pins 14, 16, 18 and 20 switch (SW) as circuit 380, etc. The chip 310 includes seventeen pins: 1: Vᵢₙ 320 that receives +24 V_{DC} from electric potential source 270, 3: EN/UV, 5: PG 360, 6: NC6, 7: DNC, 8: RT, 9: NC9, 10: TR/SS, 11: F8, 12: Vₒᵤₜ 325, 13: NC13, 14: IND, 15: NC15, 16: INTV_{cc}, 18: BST, 20: SW and 21: GND 330.

The resistors 342 include R20 at 100 kΩ, R21 at 8.66 kΩ, R22 at 1 MΩ and R23 at 71.6 kΩ. The capacitors 344 include C16 at 2.2 μF, C17 at 0.01 μF, C18 at 100 μF, C19 at 0.1 μF, C20 at 2.4 μF, C21 at 10 μF, C22 and C23 both at 22 μF, and C24 at 10 μF. The inductor 346 includes L2 at 22 μH. Pin 5 connects to capacitor C17, resistor R20 and the left IntlkSIG 340. Pin 8 connects to resistor R21. Pin 10 connects to capacitor C18. Pins 11 and 12 connect to a parallel circuit including capacitor C21, resistors R22 and R23, and capacitors C22, C23 and C24, and to the right SIG 340. Pin 16 connects to capacitor C10. Pins 14 and 20 connect through inductor L2. Pins 18 and 20 connect through capacitor C19.

FIG. 4 shows a logic diagram view 400 of a logic schematic 410.

This includes four LT8630 IC converter chips 420 denoted as U4, U13 as 310, U19 and U21 associated with four corresponding adders 430 denoted respectively as AND-1, AND-2, AND-3 and AND-4. In addition, the schematic 410 includes exclusive-or units 440 denoted respectively as XOR-1, XOR-2, XOR-3 and XOR-4, as well as an .OR. unit 450 denoted as OR-1. A switch 460 denoted as SW-1 connects to +5V_{DC} power supply 260. In addition a set of latches 480 as M1, M2, M3 and M4 connecting to ground 330 associates the IC components 420 with the adders 430. These logic components as latches 480 enable activation signals to be set.

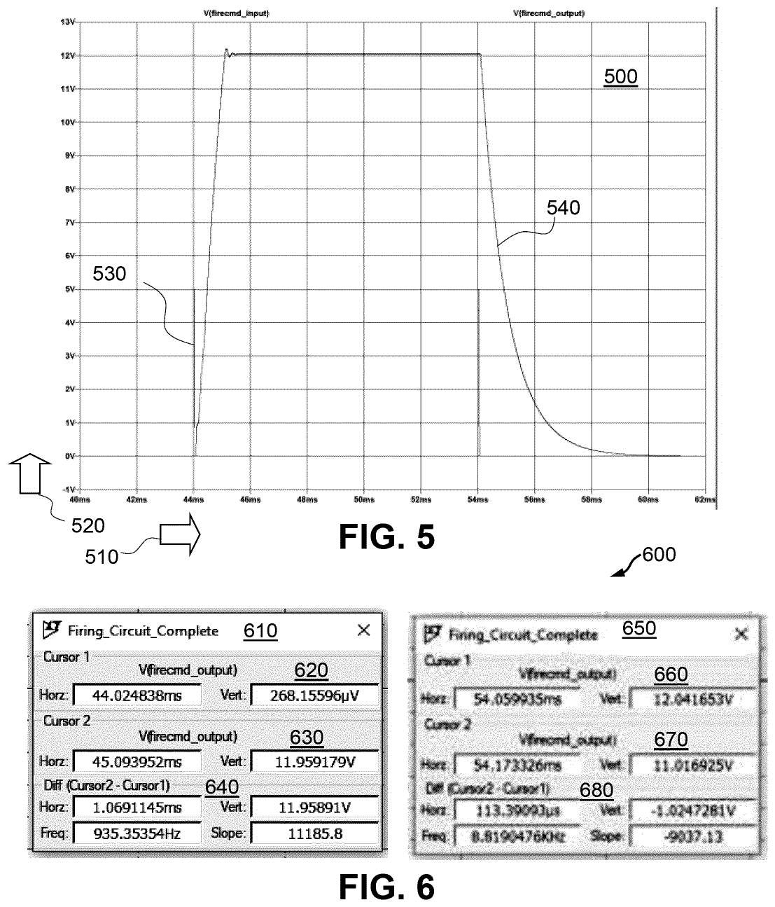

FIG. 5 shows a graphical response view 500 of a fire command signal. Time (ms) 510 represents the abscissa, while electric potential (V) 520 denotes the ordinate. An input signal 530 of +5 V_{DC} 260 starting at 44 ms and continuing for 10 ms produces an amplified output signal 540 of +12 V_{DC}, rising in 1 ms and trailing to zero after 6 ms.

FIG. 6 shows a dialog box window view 600 of fire command response parameters. In a first window 610 for output ramp-up, a first cursor 620 includes voltage of fire command output reflecting the time abscissa at 44.025 ms and voltage ordinate at 268.156 μV. A second cursor 630 includes time abscissa at 45.094 ms and voltage ordinate at 11.9592 V. A third cursor 640 presents differences of time of 1.069 ms and voltage of 11.9589 V, as well as frequency of 535.35 Hz and slope of 11.2 k.

In a second window 650 for output ramp-down, a first cursor 660 includes voltage of fire command output reflecting the time abscissa at 54.060 ms and voltage ordinate at 12.0417 μV. A second cursor 670 includes time abscissa at 54.173 ms and voltage ordinate at 11.0169 V. A third cursor 680 presents differences of time of 113.4 us and voltage of −1.0247 V, as well as frequency of 819.05 Hz and slope of −9.04 k. These values demonstrate the control available to activate and verify authorized command signals.

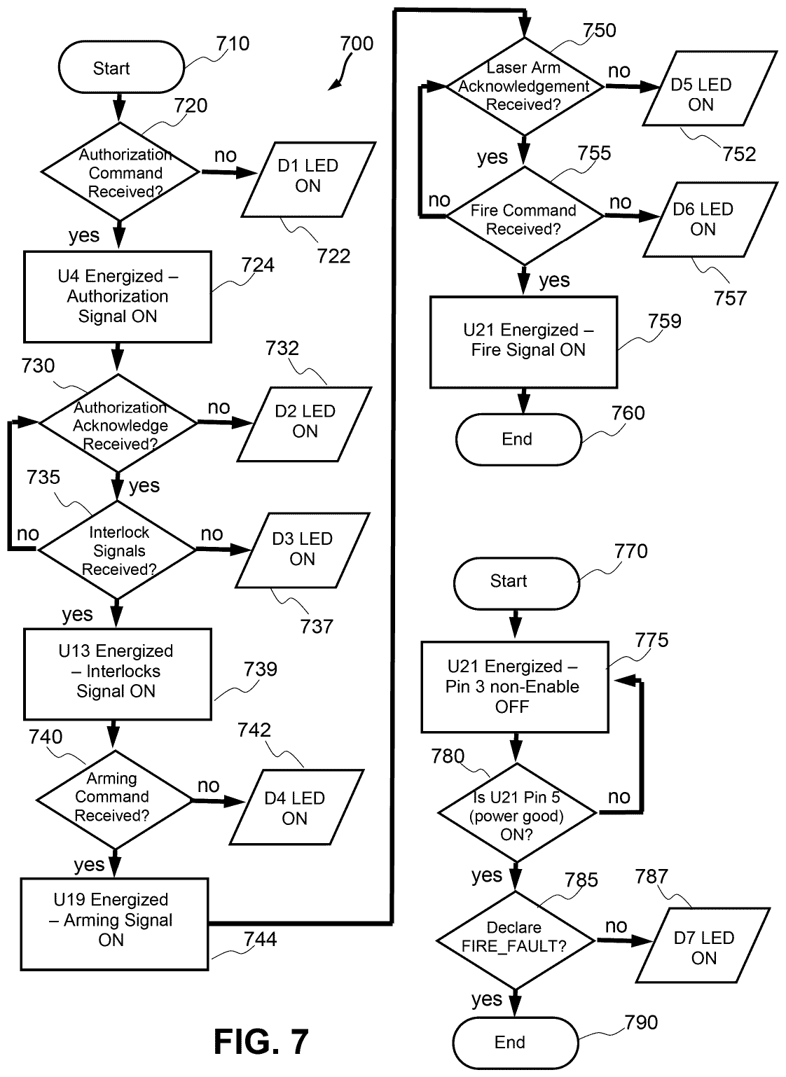

FIG. 7 shows a logic sequence diagram view 700 of an authorization command and power indication. The process begins 710 with a first query 720 regarding receipt of an authorization command. If not 722, the D1 LED activates, while if so 724, the IC converter 420 labeled U4 energizes to activate an authorization signal. The process continues with a second query 730 regarding receipt of an authorization acknowledgement. If not 732, the D2 LED activates. Otherwise a third query 735 inquires about receipt of interlock signals. If not 737, the D3 LED activates and the process returns to the second query 730. If so 739, the IC converter 420 labeled U13 310 energizes to activate an interlocks signal.

The process continues with a fourth query 740 regarding receipt of an arming command. If not 742, the D4 LED activates. Otherwise 744, a converter IC 420 labeled U19 energizes to activate an arming signal. The process proceeds to a fifth query 750 regarding receipt of laser arming acknowledgement. If not 752, the D5 LED activates. Otherwise, a sixth query 755 inquires about receipt of fire command. If not 757, the D6 LED activates and the process returns to the fifth query 750. If so 759, the converter IC 420 labeled U21 energizes to activate firing command, after which the process terminates 760 with non-enable pin 3 deactivated.

Power indication initiates 770 with energizing an IC labeled U21 energizes 775 to disable pin 3. The process continues to a seventh query 780 as to whether pin 5 is activated, confirming that power is thus good. If not, the process returns to converter U21 energizing 775 and continues to an eighth query 785 on whether to declare fire-fault. If not 787, the D7 LED activates. Otherwise, the process terminates 790.

Signals are identified as authorization command (AuthCMD) 720, authorization acknowledgement (AuthACK) 730, authorization signal (AuthSIG), authorization-and-out (AuthANDOUT), interlock (INTERLOCKSOK), arming command (ArmCMD) 740, arming acknowledgement (ArmACK) 750, arming interlock (ArmInterlock), arming signal (ArmSIG), Fire command (FireCMD) 755, fire fault (FireFLT) 785, Fire signal (FireSIG), hardware interlink (HardwareINTLNK), software interlink (SoftwareINTLK), hardware abort (HWAS), distribution system simulator (DSS), interlink signal (IntlkSIG).

FIGS. 8A and 8B show a hardware view 800 of an exemplary common firing circuit board 810, which includes integrated circuits (ICs). Components shown in FIG. 8A include diode chips 820 and gate ICs 830, with additional circuit segments arranged as example respective first and second portions 840 and 845. These portions incorporate converter ICs 420 as U4, U13 as 310, U19 and U21. Additional components include LEDs 850, resistors 860 and 865, capacitors 870 and junctions 880. FIG. 8B shows the board 810 with the connection holes identified by a legend 890.

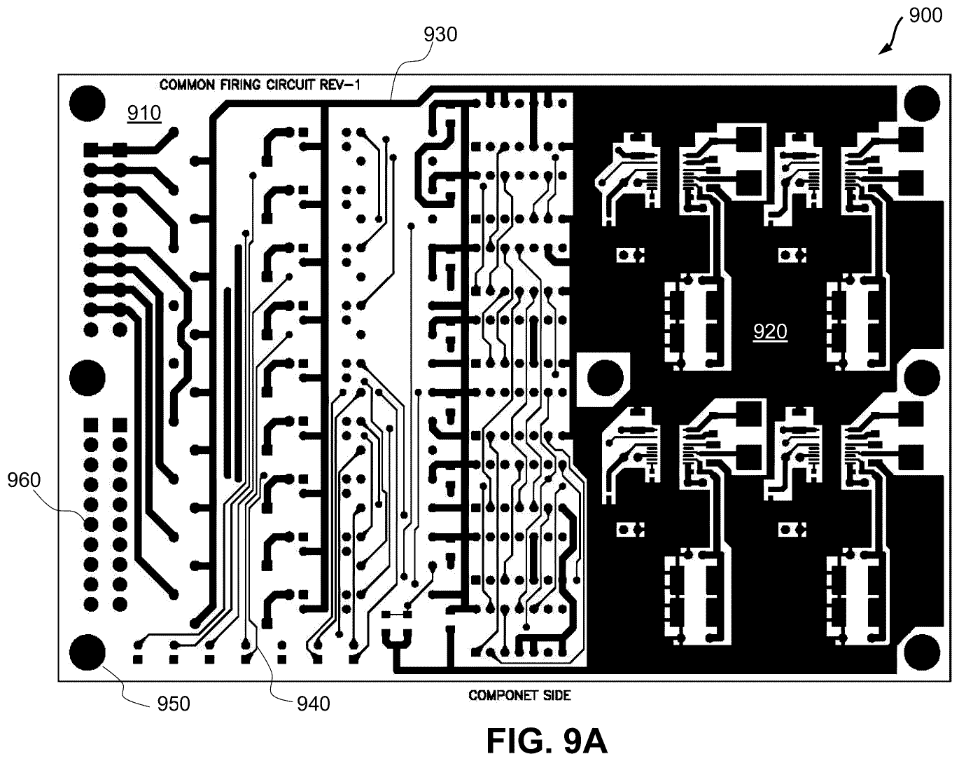

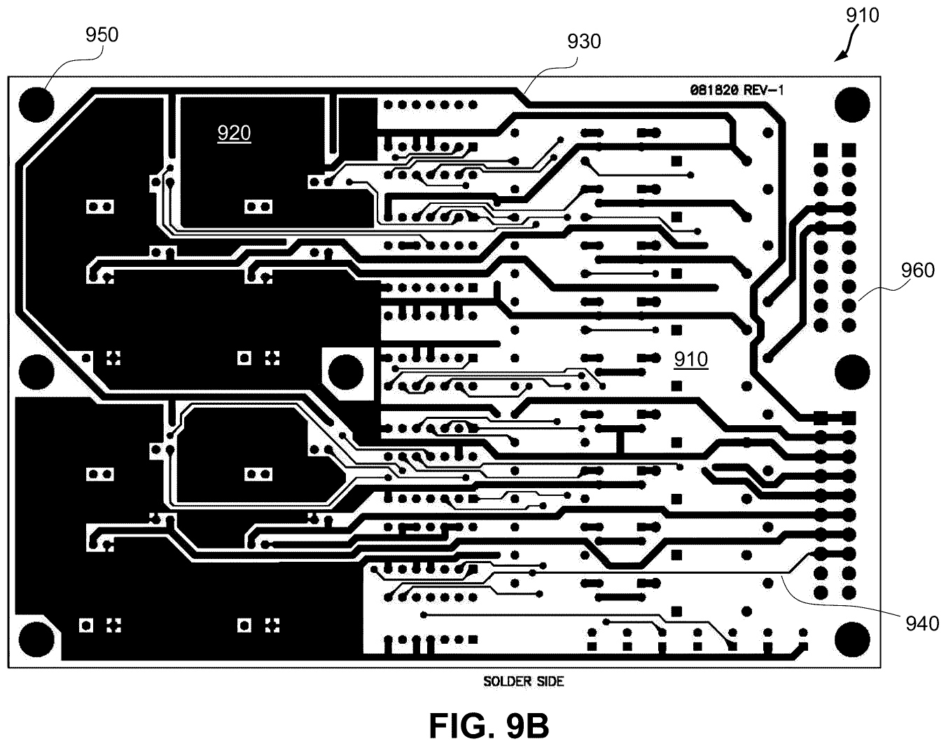

FIGS. 9A and 9B show wiring diagram views 900 of the common firing circuit board 810. FIG. 9A features the component side, while FIG. 9B illustrates the solder side. Thick lines 930 can convey power, while thin lines 940 convey signals. Mounting holes 950 enable the board 810 to be secured to a platform. Junction holes 860 provide connection ends for the junctions 880.

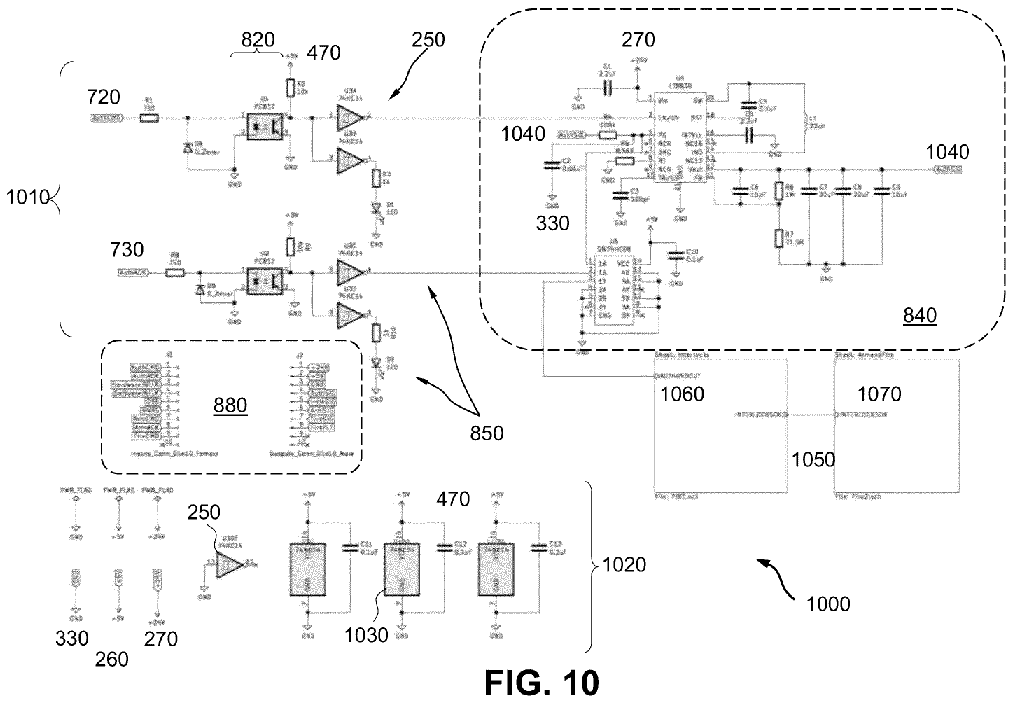

FIG. 10 shows an electric circuit diagram view 1000 of a first portion 840 of the circuit board 810 along with an authorization connecting circuit 1010 that includes diode chips 820 (e.g., U1 and U2) and LEDs 850 (e.g., D1 and D2). Other components 1020 include a plurality of hex gate chips 1030 as well as inverters 250. Connections are made to ground 330, +24 V_{DC} 270 and +5 V_{DC} 260, which connect to the junctions 880 and other circuit components.

The circuit 1010 connects to an authorization command signal 720 and authorization acknowledge signal 730. The portion 840 connects to authorization signals 1040 and includes chip U5 of the second ICs 830 as well as converter chip U4. The portion 840 connects to signals for an interface 1050, including authorization-and-out 1060 and interlock 1070. Authorization enables confirmation that the initial command is valid.

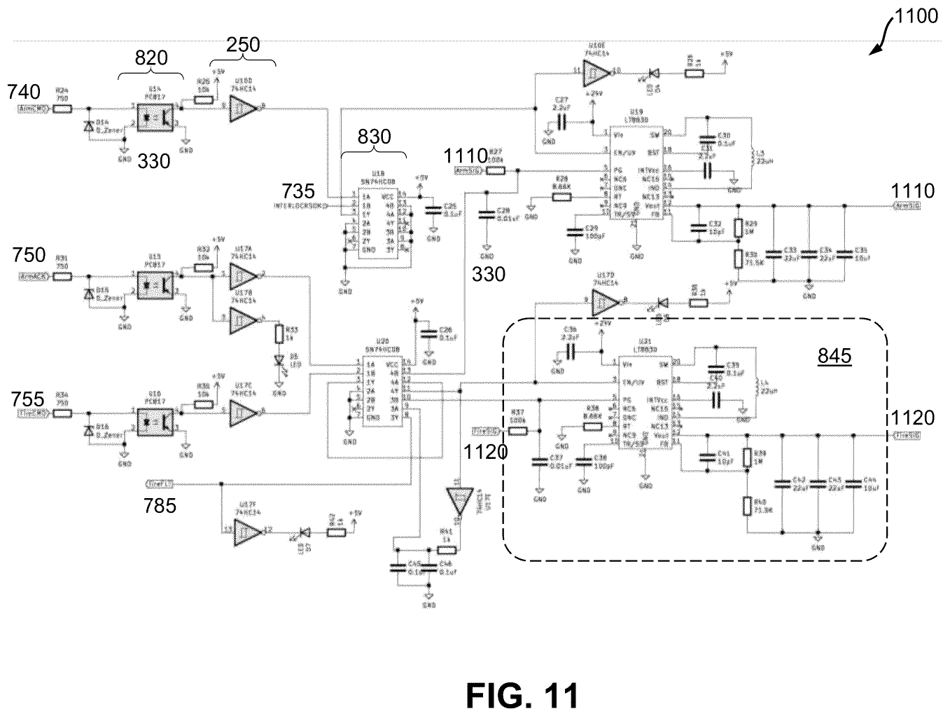

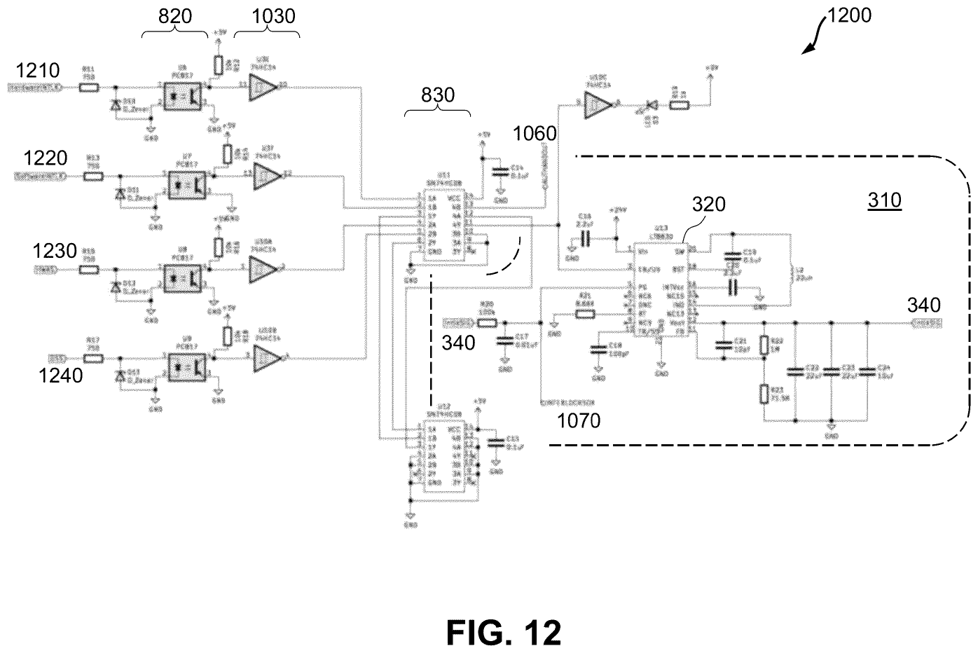

FIG. 11 shows an electric circuit diagram view 1100 of components on the circuit board 810 that include the second portion 845, including diode chips 820 (e.g., U14, U15 and U16), gate ICs 830 (e.g., U18, U19, U20 and U21) and inverters 250. The diode chips 820 connect to an arming command signal 740, arming acknowledge signal 750 and fire command 755. The ICs 830 connect to an interlock 735 (to U18), an arming signal 1110 (to U19), a fire signal 1120 (to U21) in portion 845. The arming and firing enables the system to activate the laser system in response to the command and authorization signals. FIG. 12 shows an electric circuit diagram view 1200 of portions of the circuit board 810, including the converter 280. Components include diode chips 820 (e.g., U6, U7, U8 and U9), ICs 830 (e.g., U11 and U12) and inverters 250. Signals include hardware interlink 1210, software interlink 1220, HWAS 1230, DSS 1240, interlink signal 340, authorization-and-out 1060 and interlock 1070. These hardware signals provide internal verifications that the command and control operations function properly.

The CFC requires seven inputs from the weapons console and two inputs from a laser control cabinet 180. The designed signal input voltage range of the CFC is acceptable from +5 V_{DC} to +24 V_{DC}. The CFC integration circuit card 810 also has two voltage rails in order to support all installed integrated circuit (IC) components: +5 V_{DC} 260 and +24 V_{DC} 270. All inputs to the CFC integration card 810 are received through the same architecture via opto-couplers to provide galvanic isolation between an input signal and the CFC primary circuitry. Because of this, a component-by-component description is generalized herein in order to reduce repetition.

The output of the exemplary CFC design delivers electric potential of +12 V_{DC} with an available current of 600 mA to an installed laser control cabinet 180 as well as a logic output to an installed weapons console to indicate a faulted interlock of the fire command status. To provide visual indications of status, LED components 850 are incorporated into the CFC integration card 810 to confirm CFC interlocks and major signal status.

CFC Authorization—The CFC integration circuit card 810 does not incorporate timed relays or other holding circuits in order to maintain its signals across the card. Hence, the installed weapons console and laser control cabinet 180 are required to ensure that the required staged circuits can be maintained and not simply drop out once a signal to the firing sequence has issued. The adoption of the CFC is expected require a redesign effort for these systems in future integration.

Weapon Console Interlocks—The authorization command signal 720 from a weapons console begins the sequence of logic to trigger the final output of the CFC. This command signal 720 is provided to two inverters 250 disposed in parallel serving as inputs to both the first CFC status LED (D1) 722 as well as the first LT8630 DC/DC chip U4 420. The authorization status LED (D1) indicates the beginning of the CFC initiation sequence. The output voltage Vₒᵤₜ 325 of converter U4 420 provides the first +12 V_{DC} output signal to the laser control cabinet 180 to initiate the sequence of authorizing the firing circuit 160.

The returned signal 730 from the laser control cabinet 180 to the CFC integration card 810 can be the authorization acknowledge signal 730. The authorization acknowledge LED (D2) illuminates 732 upon receipt of the authorization signal by the CFC from the laser control cabinet 180. The Power Good (PG) pin of converter U4 in portion 840 and the authorization acknowledge signal 730 from the laser control cabinet 180 are inputs to .AND. gate U5 830, thereby completing the authorization interlock 735 of the CFC card 810.

Final Commands-Arm and Fire—The weapons console provides an arm command input 740 to the CFC integration card 810, which is connected to .AND. gate U18 830, and the arm interlock 735. With the weapons console interlocks complete and the CFC integration card 810 receiving an arm command input 740, the arm interlock 735 becomes satisfied. The output of the arm interlock 735 enables the illumination of the next CFC status LED (D4) 742 as well as enables input to the next LT8630 DC/DC chip 420 (U19).

The fourth LED status indication 742 represents the completion of all previous interlocks, as well as the initiation of the arm interlock 735. The output voltage Vₒᵤₜ 325 of converter U19 420 provides the third +12 V_{DC} output to the directed energy control cabinet 180. The returned signal from the directed energy control cabinet 180 to the CFC integration card 810 becomes the arm acknowledge input signal 744. The arm acknowledge LED (D5) illuminates once the signal is received by the CFC from the laser control cabinet 180. The arm acknowledge input signal 735 and the PG output 744 of converter U19 420 enables the fire interlock as arm acknowledge 750 of the CFC integration card 810 via .AND. gate U20 830.

With both of these conditions, the actuation of the weapons console fire command 755 provides the input signal to the CFC integration card 810, which enables the illumination of the final fire status LED (D6) 757, as well as provide the input to the final LT8630 DC/DC chip 420 (U21). The sixth LED status indication 757 represents the completion of all previous interlocks as well as the initiation of the fire command 755. The output voltage Vₒᵤₜ 325 of converter U21 420 provides the fourth +12 V_{DC} output to the laser control cabinet 180, which can be used at the control signal to release the firing mechanism of the laser weapon.

As mentioned, an alarm output is provided to the weapons console. This output is provided by .AND. gate U20 830. In order for this output to become active, IC converter U21 420 must provide an output voltage in response to a low voltage condition 765 on the enable input of converter U21 420. Multiple scenarios could initiate this fault. Visual indication of a fault condition 765 can be verified by the illumination of the Fire Fault LED (D7) 787.

To provide discussion of the advantages and novel features of the CFC integration card 810, breakdown the design efforts to specific sections of the CFC integration card design are described. These include: opto-coupler, general logic ICs, LT8630 DC/DC converter chips 420 and fire alarm output. Although the combination of these major sections comprise the complete CFC architecture, each major section design discussion are based on their unique design considerations and constraints. The success of the design measures discussed below provide a flexible baseline design for all future laser weapons programs to incorporate into their own systems.

The opto-coupler's primary purpose shall be to ensure galvanic isolation between the weapon console input signal and the CFC ensuring compliance with requirements per the CFC System Requirements Document (SRD). Three primary considerations motivated the design constraints of the opto-coupler:
(1) Provide sufficient current for the follow-on device(s).
(2) Remain within the maximum collector current specifications of the transistor.
(3) Adhere to the constraints of the current transfer ratio (CTR).
(4) Ensure the power dissipation does not exceed acceptable limits.

The Taiwan Semiconductor TPC817B opto-coupler was chosen for the CFC design. The input to the opto-coupler has a maximum forward current and collector current rating of 50 mA. The opto-coupler is current-driven at the input through the use of the series resistor providing the forward current. There is a resistor in series with the collector to control the collector current. This device has a 130% to 260% CTR.

To ensure maximum flexibility of the design for future unknown integrations, the input voltage is designed to permit as low as +5 V_{DC} 260 but not greater than +24 V_{DC} 270. In addition, the appropriate power dissipation shall have a minimum margin of 100% (+10%) based on actual power experienced by the device. Based on the datasheet of the TPC817B opto-coupler, the input maximum diode power dissipation rating is 70 mW and the transistor power dissipation is 150 mW. Corner cases were reviewed to ensure all values satisfied their ratings. Establishing the required output current for the collector was first to be determined. The designed collector current value must be able to be reached following input current received at the photodiode intensity when considering the opto-couplers CTR.

The calculation to determine the designed collector current is:

$${I}_{C} = \frac{( {V}_{i n} - {V}_{sat} )}{{R}_{C}} , \qquad ( 1 )$$

where collector current I_{C}=490 mA, input voltage Vᵢₙ=5V, saturation voltage Vₛₐₜ=1.2V, and resistance R_{C}=10 kΩ. Thus, Vᵢₙ is the CFC +5 V_{DC} power supply voltage 260, Vₛₐₜ is the voltage loss due to the transistor saturation, and R_{C} is the resistor above the collector of the transistor internal to the opto-coupler. Thus, I_{C}=490 μA is the minimum current required across the opto-coupler in order to ensure a proper output.

This minimum value prevents the transistor from biasing in its linear region resulting in a faulty output signal of the opto-coupler. In order to verify that the opto-coupler is designed to satisfy its expected worst case scenario: namely the calculation of a received +5 V_{DC} signal 260 with a minimum current transfer ratio (CTR) of 130% (or 1.30). The design scenario of +5 V_{DC} input with a CTR of R_{C}=1.30 reveals an opto-coupler output current calculation:

$${I}_{out} = {R}_{CT} ( \frac{{V}_{i n} - {V}_{drop}}{R} ) = {R}_{CT} \cdot {I}_{f} , \qquad ( 2 )$$

where current Iₒᵤₜ=6.6 mA, input voltage Vᵢₙ=5 V, potential drop V_{drop}=1.2 V, and resistance is R=750Ω.

Because Iₒᵤₜ exceeds the 490 μA calculated eqn. (1), the opto-coupler is designed to function appropriately at the lowest input levels where the most risk of a faulty output signal is of concern. Designing an electric current value as low as 490 μA also ensures that in the event of a damaged internal LED 850 of the opto-coupler, reliability of the component increases by requiring such a low current. As previously stated, power dissipation is one of the four driving motivations of the opto-coupler circuit design. In order to maximize reliability of the opto-couplers for long-term use. This ensures a healthy margin to the components power limits is required; a margin of 100% (±10%) has been chosen to be the design criteria.

Maximum opto-coupler input current expected is provided as:

$${I}_{f} = \frac{{V}_{i n} - {V}_{drop}}{R} , \qquad ( 3 )$$

and maximum expected power dissipation is provided as:

$${P}_{d} = {I}_{f} \cdot {V}_{f} , \qquad ( 4 )$$

where input current I_{f}=30.4 mA, input voltage Vᵢₙ=24 V, voltage drop V_{drop}=V_{f} 1.2 V and resistance R=750Ω, yielding power dissipation P_{d}=36.48 mW. Due to the 70 mW diode rating and the 1.2 V forward voltage drop over the diode, eqns. (3) and (4) provide the designed calculated current and expected input power of the circuit. A worst case value of +24 V_{DC} at the input was selected for this calculation.

Based on the results of eqns. (3) and (4), the maximum input current to the opto-coupler is I_{f}=30.4 mA with a power consumption of 36.5 mW. Both of these values satisfy the design requirement specified above of the opto-coupler to ensure long-term reliability. In the event an input receives a value of +24 V, a significant voltage drop occurs over the input resistor 342.

Because of this, the expected power dissipation over the input resistor 342 must be understood to ensure a properly sized resistor 342 is used for the input to the photodiode of the opto-coupler. Input resistor power dissipation is calculated as:

$${P}_{R} = \frac{( {V}_{i n} - {V}_{drop} )}{R} , \qquad ( 5 )$$

where resistor power P_{R}=393 mW, input voltage Vᵢₙ=5V, potential drop V_{drop}=1.2 V and resistance R=750Ω.

A minimum two-times (2×) the calculated expected power should be used for the resistor sizing. Based upon supplier availability, 2 W capable resistors 342 were selected for the input of the opto-couplers. Logic devices include inverters 250 and .AND. gate 830.

There are three inverters 250 (U3, U10, U17) and five .AND. gates (U5, U11, U12, U18, U20) among the gate LCS 830. The CFC design uses the CD74HC14 inverter 250 for mainly two primary scenarios: Output of the opto-couplers, and providing an inverter buffer circuit for LED status indicators. For the inverters 250 at the output of the opto-couplers, due to them receiving an initial low input from the output of an opto-coupler, the inverter 250 therefore provides a high +5 V_{DC} input to each respective device an inverter 250 is tied to. With the exception of the authorization command input signal 720, all initial inverters 250 immediately after the opto-coupler feed into an .AND. gate 830 (e.g., SN74HC08). The inverter 250 operates on a +5 V_{DC} supply voltage 260 from the CFC +5 V_{DC} rail and ensures a steady +5 V_{DC} output signal.

An inverter 250 is used to create a buffer circuit prior to each LED status indication of the CFC. These LEDs 850 provide visual indication of the sequential buildup of interlock stages and received inputs from the weapons console or laser control cabinet 180 to the CFC integration card 810. This buffer circuit isolates each respective LED 850 from the primary logic path that the EN/UV input pin of the LT8630 DC/DC chip 420 is tied to ensuring a steady input. In order to minimize the use of inverters 250, the anode and cathode of each LED 850 are uniquely positioned based on the voltage condition (high/low) prior to the inverter 250.

All .AND. gates 830 within the CFC integration card 810 serve as the primary interlocks 130 of the design. The interlocks 130 are designed to be a cascading architecture throughout the circuit board 810, and in the event during the construction of the CFC an input is dropped, all interlocks downstream of that input shall open. This architecture ensures a continuous signal path of primary inputs from both the weapons console 110 and laser control cabinet 180 throughout the firing sequence. All ICs on the CFC integration card 810 incorporate a 0.1 μF decoupling capacitor at their V_{cc} pin. This decoupling capacitor provides noise immunity against unexpected and unstable input voltages from the CFC voltage rail connections.

LT8630 DC/DC Converter—The Linear Technologies LT8630 DC/DC chip 420 was chosen as a power efficient and flexible option to achieve the various sequential voltage steps required throughout the design of the CFC integration card 810. The converter circuit 280 receives an input from the .AND. gate interlocks and provide a steady +12 V_{DC} output signal to the laser control cabinet 180. Design considerations around each of the various input/output pins of the integrated circuit 810 are described herein.

View 300 provides an overview of one of the circuit architecture of the LT8630 sub-circuit for reference. All designs for the LT8630 DC/DC chips 310, 420 are identical. All specific capacitors 344 and resistors 342 previously specified are in reference to view 300, but can be applied to the three other converters 280 with the understanding that the specific capacitors 344 or resistors 342 have a distinct numerical identifier.

Vᵢₙ—The Vᵢₙ pin 320 should be connected to the CFC's +24 V_{DC} power supply 270. The 2.2 μF capacitor 344 annotated as C16 in view 300 is a standard ceramic capacitor 344 located as close as possible to the Vᵢₙ pin 320. The voltage of the capacitor 344 shall be rated for 100 V_{DC} and use a stable X7R dielectric.

EN/UV—This pin of the LT8630 DC/DC chip 420 receives the signal from its respective connected .AND. gate 830 or signal source. Voltage applied to the EN/UV input signify that all previous interlocks have been completed and for the converter 280 to output its signal to the laser control cabinet 180. This input is a passive complementary metal-oxide-semiconductor (CMOS) input requiring little current to be sourced from the output of the connected .AND. gate 830.

The “Power Good” pin 5 serves as a logic input 760 to downstream circuitry of the CFC design. The PG 360 signal for pin 5 sinks current when the feedback voltage deviates from the regulation point by ±7.5%. Initial ringing was identified in the circuit as voltage increased to steady-state. The resistor-capacitor combination, R20 and C17, was disposed to eliminate the identified ringing and serve to provide a quick and stable response. Because pin 5 to PG 360 is limited to sinking 900 μA, a 100 kΩ resistor was chosen to limit the circuit to 120 μA.

INT V_{cc}—The LT8630 420 contains an internal 3 V linear voltage regulator is used to provide bias for its internal components. The INTV_{cc} pin requires a 2.2 μF decoupling capacitor, C20. The capacitor should be a temperature stable X7R dielectric rated for 10 V.

The soft-start pin 10 requires a capacitor C18 between that pin and ground 330. Capacitor C18 determines the output voltage ramp rate of the LT8630 DC/DC chip 420. An internal 4.5 μA source charges the soft start capacitor. Once the charge across the capacitor reaches 0.808 V the LT8630 chip 420 begins regulating from the FB pin 11. The output voltage 325 at pin 12 of the LT8630 DC/DC chip 420 linearly ramps from zero to the designed output voltage at a rate governed by the current source and value of the soft-start capacitor. This ramp rate delay prevents excessive inrush currents as well as keeping peak output currents below the maximum rating of the converters internal MOSFET.

For the CFC, a delay of 18 us has been chosen. The TR/SS capacitor value was determined in accordance with the datasheet. Capacitance can ban be calculated for TR/SS at pin 10 as:

$$C = \frac{{T}_{ramp} \cdot {I}_{ce}}{{V}_{ce}} \qquad ( 6 )$$

where ramping time Tᵣₐₘₚ 18 μs, I_{cc}=4.5 μA and V_{cc}=0.808 V. The minimum TR/SS capacitor value is C=100 μF. The capacitor 344 shall be rated for 10 V_{DC} and be a temperature stable X7R dielectric.

RT—The RT pin 9 is connected to the internal clock of the LT8630 DC/DC converter 280 and requires an 8.66 kΩ resistor R21. RST—The 0.1 μF capacitor 344 is placed between the switch node SW as pin 20 and boost supply pin BST as pin 18.

Capacitor C19 and the BST capacitor from pin 18, couples flyback alternating current (AC) voltage from the inductor switch node SW as pin 20 back into the DC/DC converter 280 so that a metal oxide semiconductor field effect transistor (MOSFET) drive voltage in excess of the input voltage can be generated. This is needed to fully saturate the switch MOSFET inside the DC/DC converter 280, and the capacitors 344 must withstand a peak voltage of +10 V_{DC}. The capacitor C19 will be a temperature-stable X7R dielectric and rated for 25 V.

SW—The LT8630 chip 420 does not have a fixed clock regulating its switching frequency. Because of this, the frequency is dependent on the inductance used in the converter 280, input voltage 320, output voltage 325 and load current. The LT8630 chip 420 is designed to provide at least 600 mA of output current. The chip's datasheet recommends a minimum value of 15 pH to ensure proper boundary mode operation. The nominal switch node capacitance is about 140 μF for maximum output current, and thus can be determined as:

$${I}_{ma x} = min \{ \frac{1}{2} \cdot ( 1.8 - \frac{{V}_{i n} - {V}_{out}}{\sqrt{L / C}} , 600 mA ) \} , \qquad ( 7 )$$

where L2 inductance for L=22 μH, capacitance C=140 μF, Vᵢₙ=24 V_{DC} and Vₒᵤₜ=12 V_{DC}, resulting in maximum current Iₘₐₓ=600 mA. Given the +12 V_{DC} output at pin 12, a 22 μH inductor L2 permits the LT8630 chip 420 to achieve its full rated 600 mA of current given a 24 V_{DC} input voltage 270.

IND—This input pin 14 connects to the internal sense resistor that measures current flowing in the inductor L2. Vₒᵤₜ 325 at pin 12 receives +12 V_{DC} potential—Resistor Voltage Divider—R22 and R23 create a resistor voltage divider that sets the output of the LT8630 DC/DC chip 420, having an internal reference voltage of 0.808 V.

An output voltage of +12 V_{DC} enables a bias current of 11.3 μA to flow back to the FB pin 11 for a feedback reference provides the calculation of resistors R22 and R23. The voltage divider values are derived as:

$${R}_{23} = \frac{{V}_{ref}}{{I}_{bias}} , \\ and \qquad ( 8 )$$

$${R}_{22} = {R}_{23} \cdot ( \frac{{V}_{out}}{{V}_{ref}} - 1 ) , \qquad ( 9 )$$

where reference voltage V_{ref}=0.808 V, bias current I_{bias}=11.3 μA, so resistor R₂₃=71.5 kΩ, and output voltage Vₒᵤₜ=12 V, so R₂₂=990.4 kΩ. A value of 1 MΩ was chosen for resistor R22 due to LT8630 example configuration, availability of component, and close approximation to the calculated value.

Output Capacitor—The output capacitance value was chosen in accordance with the LT8630 chip 420 with a recommended minimum capacitance value of 47 μF. This comprises two 22 μF capacitors and one 10 μF capacitor C22, C23, and C24 respectively. Having these capacitors 344 in parallel provides an overall lower effective series resistance resulting in a more stable output voltage. The output capacitors 344 use temperature stable X7R materials and have a rating of +24 V_{DC} operation. The added voltage rating ensures minimal capacitance loss due to bias effects when a DC voltage applies as advised by the datasheet.

Phase Lead Capacitor as circuit 370 for pins 12 and 11: Vₒᵤₜ—FB capacitor—The C21 capacitor 344 ensures the LT8630's voltage feedback loop has adequate stability due to the large resistor voltage divider combination. The LT8630 datasheet recommends a value between 4.7 μF and 22 μF; modeling and simulating the circuit found that 10 μF provides good performance and represents the recommended value of the +24 V_{DC} to +12 V_{DC} DC/DC converter application. FB—The pin 11 is the negative input to the error amplifier internal to the LT8630 chip 420. The output switches to regulate this pin to 0.808 V with respect to the GND pin 21 to ground 330.

CFC modeling and simulation—The CFC integration card design was initially modeled and developed using open source LTSpice software. This software enabled the design team to verify initial calculated design efforts and identify early component integration issues. The result of using extensive modeling efforts early in the design prevented unnecessary procurement of prototype assemblies as well as to enable the design team to characterize the design to provide a non-intuitive understanding of the circuit's behavior once physical testing began.

The model developed for the CFC effort is complete with delayed input signals to simulate the physical operator delay as the firing sequence builds over time. All inputs to the CFC circuit that represented inputs from either the weapons console or a laser control cabinet were represented by individual DC sources. Input voltage values across the full design range of +5 V_{DC} to +24 V_{DC} were simulated to verify calculated design equations.

Test cases of the CFC model included both quick input signal rise and fall times (25 μs) as well as slower rise and fall times (1 ms). Simulations of the CFC model were transient time-domain simulations with a run-time of generally 50 ms-150 ms to enable an adequate number of output cycles of each LT8630 chip 420 while minimize simulation-processing time.

View 500 provides a plot of only one cycle of the simulated input fire command with 25 us rise and fall times against the final LT8630 chip as the CFC converter U21 420 with an output voltage of +12 V_{DC}. In order for circuit U21 420 to receive its EN input, the authorization acknowledge input signal 730 was held constant to enable an independent study of the response time of converter U21 420 based on receiving the final fire input command 755.

View 600 shows the simulated response time from the instant the CFC circuit receives the input to the time the LT8630 chip 420 responds. View 500 shows fire command input versus output. The LT8630 chip 420 achieving a +12 V_{DC} output signal 325 at approximately 1.069 ms after the input signal is provided to the CFC integration card 810 at the signal reaches a high input value, in the case of the simulation +5 V_{DC} was used. As indicated in view 600, the LT8630 chip 420 achieves a +11 V_{DC} output signal at approximately 113.39 us after the input signal is set low to the CFC integration card 810. The +11 V_{DC} is significant due to the LT8630 “turning off” its pin 5 as PG 360 when Vₒᵤₜ reaches ±7.5% of its regulated voltage, which is set by the R39 and R40 voltage divider. For the simulation effort shown in plot view 500, a 20Ω resistor was used to characterize the input to output response of the fire signal 755.

Prototype Printed Circuit Board PCB Arrangement. DWB Design Inc. assisted in component layout and assembly of all procured prototypes during the development period. The CFC integration card 810 is a two-layer printed circuit board (PCB) as shown in views 900. The physical extent of the PCB is 4.2″×6.2″. For the purposes of the prototype that has been developed, all components on the PCB are currently through-hole devices, with the exception of those components around the LT8630 DC/DC chip 420 that the manufacture recommended to be surface mount devices.

The CFC integration card 810 requires two connectors 880, J1 and J2. These connections are terminations of multi-conductor cables that make up all of the required inputs and outputs that the board requires as previously discussed. Efforts were made to maximize board organization by arranging all components in a sequential logical manner in grouping appropriate devices within the same vicinity. When provided by datasheets, component placement and packaging details were followed to ensure all components would operate as expected. The PCB presently requires seven mounting screws in-order to ensure minimal vibrations while secured in a case during excessive force events.

In order to complete the full cycle of tests, multiple power supplies are required: +5 V_{DC}, variable +5 V_{DC} to +24 V_{DC}, and a +24 V_{DC}. Throughout the test sequence, constant +5 V_{DC} and +24 V_{DC} voltages were provided for the applicable ICs that require them. The variable +5 V_{DC} to +24 V_{DC} power supply enabled experimentation with varying input voltages to gage the stability of the CFC design.

All input power was delivered to a series of breadboards that enables the voltage levels to distribute as required in accordance with the test plan. The specific breadboard detailed design is not captured in the test plan's instructions, although this document does account for the functionality and approach in which the test setup achieved. All inputs signals were controlled by individual dip switches 470. These switches 470 enable cycling various input combinations to verify the combinational logic interlocks built into the CFC integration card 810.

Interlock Flip Flop Integration—During the FY20 prototype testing period, an inherent firing sequence vulnerability was identified. The firing sequence as previously stated is based on the completion of .AND. gates 830 establishing combination logic interlocks. After an interlock was established and then unexpectedly lost, the input could simply be restored without requiring a reset of the proper firing sequence.

The ability to restore inputs without resetting the firing sequence introduces potential unknown conditions and uncontrolled behavior of the firing sequence. Preliminary efforts were dedicated to developing a concept design to ensure that during this scenario with an unexpected lost input, the firing sequence would need to be restarted from the authorization command input. However, the preliminary design and logic development could be modified so that during this scenario, another starting point within the sequence could be chosen resulting in a reset point other than the beginning of the firing sequence. View 400 provides a high level block diagram of the initial SR flip-flop architecture design integrated into the existing CFC circuit design.

View 400 demonstrates the CFC with an SR flip-flop integrated from the authorization command to the fire command. This shows the ability to operate the circuit by switch SW-1 (initially envisioned as a key switch). When SW-1 is set, the Q output of SR-1 is provided, enabling the circuit to be on standby for its first received input. Because an SR flip-flop retains memory of a set condition, SW-1 shall be momentary. This enables incorporating a later trip of the circuit in the event of an unexpected high at the R value of SR-1 or when the circuit completes its fire sequence.

When input U3-2 is provided to AND-1, the output is provided to the EN of converter U4. SR-2 awaits its input from the PG pin of converter U4 420, which is used as a logic input based on the output of Vₒᵤₜ 325 as described above. The output of the PG pin of converter U4 420 provides inputs to the following: XOR-1, SR-2 (S), and AND-2. Because SR-2 is provided a high input to its S input, SR-2 will provide an output at its Q output. This output is provided as the second input to XOR-1. Under these conditions, XOR-1 provides a low output to OR-1, which will only provide a high output to reset the circuit when the gate has a single high input.

The pattern of flip-flop behavior is repeated throughout the circuit as OR-1 builds its active low inputs. In the event that any of the connected CFC inputs is dropped unexpectedly or the circuit completes its firing sequence and ordered to drop all inputs, the PG pin 5 of the applicable LT8630 U-gate goes low resulting in a high output of the applicable .XOR. gate. The result is OR-1 providing a high output and dropping out the circuit forcing a controlled reset of the firing sequence.

Two modifications to the CFC design have been considered to improve the inherent controllability and safety of a future laser weapon system: providing both a soft-switch at U21 420 for Vᵢₙ 320 and a differential output of −12 V_{DC} and +12 V_{DC} at converter U21 420.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. An electronic circuit for laser firing control of a directed energy weapon, said circuit comprising:
a command circuit for issuing an initiation of the weapon by providing an authorization command signal;
an acknowledge circuit for interlocking said command signal and providing an interlock signal;
an arming circuit for issuing an arming signal to energize the weapon in response to said interlock signal; and
a firing circuit for issuing a firing signal to activate the weapon in response to said arming signal.

2. The circuit according to claim 1, further including:
a fire fault circuit for deactivating said firing circuit in response to inadequate power to said firing circuit.

3. The circuit according to claim 1, further including:
a plurality of light emitting diodes (LEDs) activate in response to at least one of said command, interlock, arming and firing signals.

4. The circuit according to claim 1, wherein at least one of said command, acknowledge, arming and firing circuits includes a voltage converter chip.

5. The circuit according to claim 4, wherein said converter chip is an LT8630 processor that receives +24 V_{DC} as input potential and provides +5 V_{DC} as output potential.
